(19) United States
(12) Patent Application Publication
(10) Pub. No.: US 2010/0056069 A1
(43) Pub. Date: Mar. 4, 2010

(54) WIRELESS COMMUNICATION APPARATUS

(75) Inventors: Kiyoshi Toshimitsu, Tokyo (JP); Masahiro Takagi, Tokyo (JP)

Correspondence Address: OHLANDT, GREELEY, RUGGIERO & PERLE, LLP, ONE LANDMARK SQUARE, 10TH FLOOR, STAMFORD, CT, 06901, US

(73) Assignee: KABUSHIKI KAISHA TOSHIBA

(21) Appl. No.: 12/408,487

(22) Filed: Mar. 20, 2009

(30) Foreign Application Priority Data
Aug. 27, 2008 (JP) 2008-218385

(51) Int. Cl. H04B 1/40; H04B 1/38; H04L 27/06

(52) U.S. Cl. 455/75; 375/260; 375/344

(57) ABSTRACT

A wireless communication apparatus receives a radio signal, compensates a frequency offset of received radio signal, stores, in a memory, a frequency offset of the received radio signal which includes an address used as a destination of a transmission signal, compensates a frequency of the transmission signal having the address as the destination by using the frequency offset stored in the memory, and transmits the transmission signal whose frequency is compensated.

### CROSS-REFERENCE TO RELATED APPLICATIONS

This application is based upon and claims the benefit of priority from prior Japanese Patent Application No. 2008-218385, filed Aug. 27, 2008, the entire contents of which are incorporated herein by reference.

### BACKGROUND OF THE INVENTION

1. Field of the Invention

The present invention relates to a wireless communication technique and, more particularly, to a frequency compensation technique.

2. Description of the Related Art

There is known a reference (JP-A 2003-283359(KOKAI)) about a frequency synchronization scheme for MU-MIMO (Multi User-Multi Input Multi Output), SDMA (Space Division Multiple Access), and OFDMA (Orthogonal Frequency Division Multiple Access). This reference describes a frequency synchronization technique for MIMO. The wireless communication apparatus described in the above reference includes a plurality of multipliers which respectively multiply a plurality of reception signals from a plurality of antennas by carrier waves, and a frequency offset estimation unit which estimates frequency offsets on the basis of signals from the respective multipliers on the basis of the estimated frequency offsets. This apparatus performs frequency offset compensation for output signals from the plurality of multipliers. The disclosed technique is, however, based on the assumption that basic frequency synchronization has been established between a base station and terminals by matching VCO frequencies in advance, and has an object to compensate slight frequency offsets caused by fading and the like.

Each wireless communication apparatus constituting a wireless communication system based on CSMA, like a wireless LAN, needs to receive all radio signals transmitted from not only other wireless communication apparatuses belonging to the same network but also wireless communication apparatuses belonging to other networks. For this reason, each wireless communication apparatus uses a scheme of transmitting a radio signal with reference to its own VCO and causing the receiving side to compensate a frequency offset by performing coarse synchronization/fine synchronization every time it receives a packet. If, therefore, MU-MIMO, SDMA, and OFDMA are performed on an uplink in such a CSMA system by using the conventional technique, radio signals transmitted from the respective wireless communication apparatuses are likely to interfere with each other due to large frequency offsets in the signals.

As described above, the conventional technique has a problem that the frequency offset between wireless communication apparatuses cannot be compensated if the offset is large.

In addition, if the frequency offsets between a plurality of wireless communication apparatuses are large, it is impossible to perform spatial multiplexing (e.g., MU-MIMO or SDMA) communication or orthogonal frequency division multiple access (OFDMA) communication.

### BRIEF SUMMARY OF THE INVENTION

According to embodiments of the present invention, a wireless communication apparatus comprises:

a reception unit configured to receive a radio signal;

a reception frequency compensation unit configured to compensate, every time the radio signal is received by the reception unit, a frequency offset of the radio signal;

a control unit configured to store, in a memory, the frequency offset of the radio signal which is received by the reception unit and includes an address used as a destination of the transmission signal;

a transmission frequency compensation unit configured to compensate a frequency of the transmission signal having the address as the destination by using the frequency offset stored in the memory; and

a transmission unit configured to transmit the transmission signal whose frequency is compensated by the transmission frequency compensation unit.

### BRIEF DESCRIPTION OF THE SEVERAL VIEWS OF THE DRAWING

FIG. 1 is a block diagram showing an example of the arrangement of a wireless communication apparatus according to an embodiment of the present invention;

FIG. 2 is a block diagram showing another example of the arrangement of the wireless communication apparatus according to the embodiment of the present invention;

FIG. 3 is a block diagram showing another example of the arrangement of the wireless communication apparatus according to the embodiment of the present invention;

FIG. 4 is a chart showing a communication sequence between wireless communication apparatuses (a plurality of wireless stations and a wireless base station) according to the first embodiment;

FIG. 5 is a chart showing another communication sequence between the wireless communication apparatuses (the plurality of wireless stations and the wireless base station) according to the first embodiment;

FIG. 6 is a chart showing a communication sequence between wireless communication apparatuses (a plurality of wireless stations and a wireless base station) according to the second embodiment;

FIG. 7 is a chart showing a communication sequence between wireless communication apparatuses (a plurality of wireless stations and a wireless base station) according to the sixth embodiment;

FIG. 8 is a chart showing a communication sequence between wireless communication apparatuses (a plurality of wireless stations and a wireless base station) according to the seventh embodiment;

FIG. 9 is a chart showing another communication sequence between the wireless communication apparatuses (the plurality of wireless stations and the wireless base station) according to the seventh embodiment;

FIG. 10 is a flowchart for explaining the processing operation of a wireless communication apparatus according to the first to fifth embodiments of the present invention; and

FIG. 11 is a flowchart for explaining the processing operation of a wireless communication apparatus according to the sixth and seventh embodiments of the present invention.

### DETAILED DESCRIPTION OF THE INVENTION

### First Embodiment

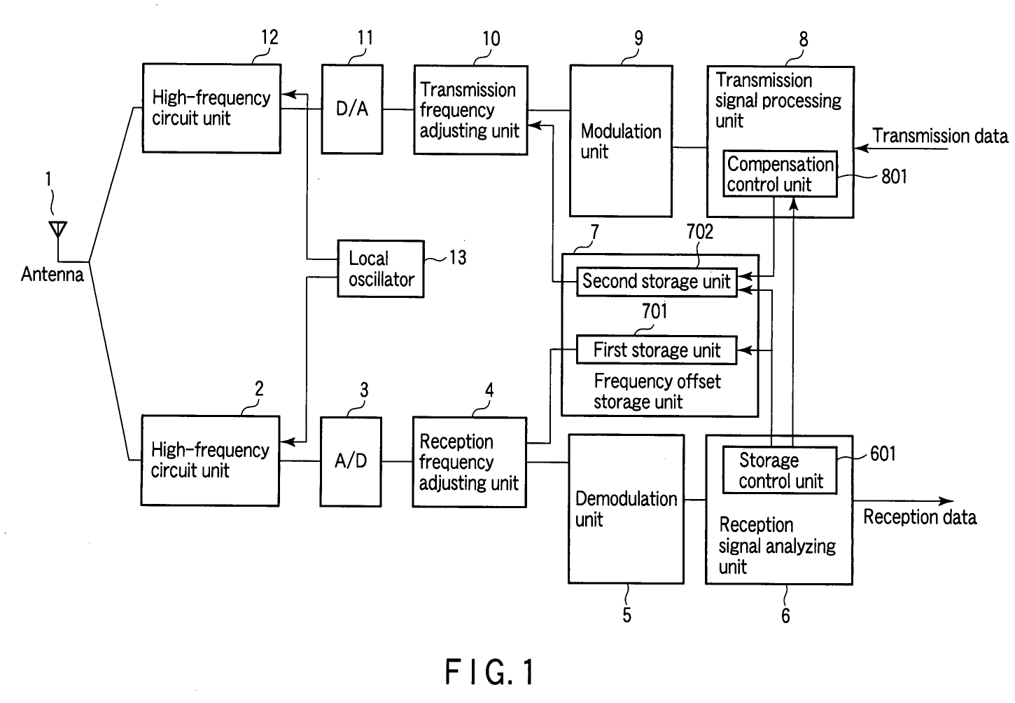

The wireless communication apparatus (transmission/reception apparatus) in FIG. 1 includes an antenna 1, a high-frequency circuit unit 2, an A/D converter 3, a reception frequency adjusting unit 4, a demodulation unit 5, a reception signal analyzing unit 6, a frequency offset storage unit 7, a transmission signal processing unit 8, a modulation unit 9, a transmission frequency adjusting unit 10, a D/A converter 11, and a high-frequency circuit unit 12.

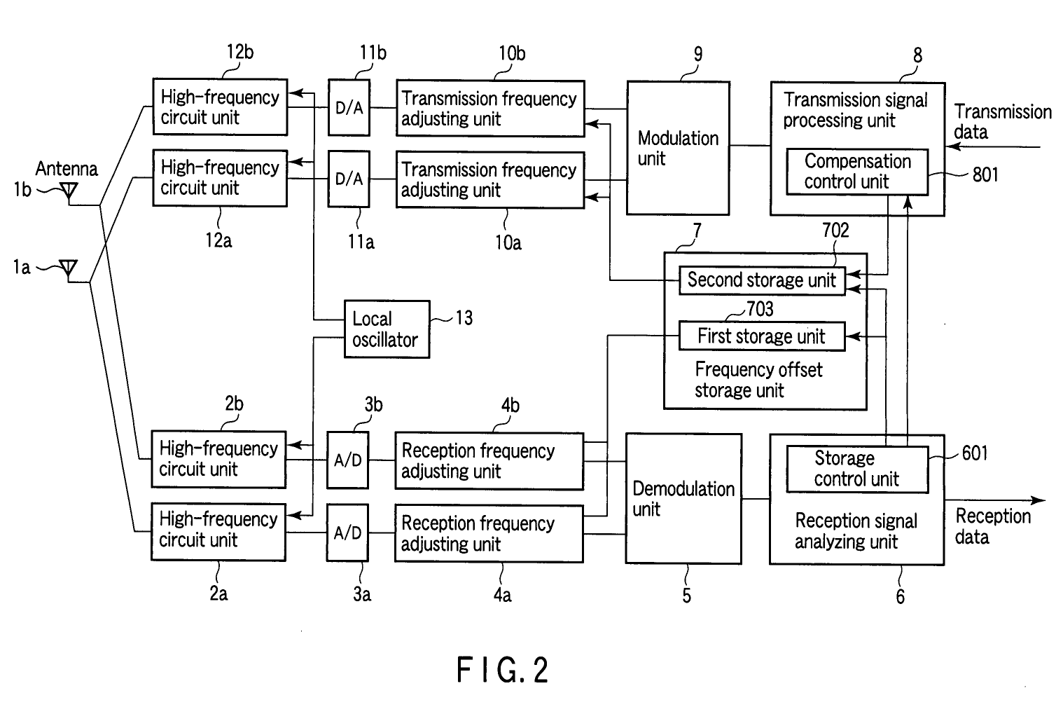

The antenna 1 is an element for receiving and transmitting radio waves. Referring to FIG. 1, one antenna is used for transmission and reception. However, different antennas can be used for transmission and reception, respectively. Alternatively, as shown in FIG. 2, this apparatus can have a plurality of antennas (e.g., two antennas in FIG. 2) to implement MIMO. The following exemplifies a case in which one antenna is used for both transmission and reception.

The high-frequency circuit unit 2 includes a filter, an amplifier, a frequency converter, and a quadrature demodulator. The high-frequency circuit unit 2 generates a baseband signal by downconverting the frequency of the signal received by the antenna 1 from the carrier frequency band to the baseband by using an output signal (frequency signal) from a local oscillator 13.

The A/D converter 3 converts the analog signal output from the high-frequency circuit unit 2 into a digital signal. The reception frequency adjusting unit 4 detects a frequency offset in the signal output from the A/D converter 3. For example, a frequency offset is detected by tracking a change in the phase of known information or the like using a preamble or header located near the head of a frame of a reception signal or a pilot signal contained in a reception frame. An OFDM system can also detect a frequency offset on the basis of a correlation with a guard interval portion added by copying part of a signal. Frequency compensation is performed by determining a frequency offset on the basis of the detected frequency offset.

The wireless communication apparatus according to this embodiment temporarily holds, in a first storage unit 701 in the frequency offset storage unit 7, the frequency offset used to compensate a frequency offset in a reception signal. The first storage unit 701 stores a frequency offset of a frame reception every time a frame is received. If, for example, the number of frequency offsets which can be stored in the first storage unit 701 is one, the frequency offset stored in the first storage unit 701 is overwritten by a newly obtained frequency offset. Assume that the number of frequency offsets which can be stored in the first storage unit 701 is plural. In this case, when the number of frequency offsets stored in the first storage unit 701 reaches the upper limit, the stored values are sequentially deleted from the earliest value (in chronological order), and a new frequency offset is stored.

The demodulation unit 5 performs demodulation/decoding processing for the frequency-compensated signal.

The reception signal analyzing unit 6 analyzes the demodulated/decoded signal to, for example, acquire the frame type, destination address, and transmission source address of the reception frame and perform a CRC check on the reception frame. The reception signal analyzing unit 6 then converts the data in the reception frame into data in a desired data format, and transfers the resultant data as reception data to an upper layer.

The reception signal analyzing unit 6 according to this embodiment further includes a storage control unit 601. The storage control unit 601 determines, on the basis of the address contained in the reception frame, the type of frame, or the like, whether to store the frequency offset of the reception frame (the frequency offset stored in the first storage unit 701) in a second storage unit 702. If the storage control unit 601 chooses to store the value, the frequency offset temporarily stored in the first storage unit 701 of the frequency offset storage unit 7 is stored in the second storage unit 702. A control method in the storage control unit 601 will be described later.

The transmission signal processing unit 8 generates a predetermined frame from the transmission data received from the upper layer. Depending on the transmission data, it is necessary to compensate a frequency offset at the time of transmission. A compensation control unit 801 of the transmission signal processing unit 8 determines whether to compensate the frequency offset. If the compensation control unit 801 determines that compensation is necessary, the transmission signal processing unit 8 performs frequency compensation for the transmission signal by using the frequency offset stored in the second storage unit 702.

The modulation unit 9 performs modulation/coding processing for the signal generated by the transmission signal processing unit 8.

If the compensation control unit 801 determines that compensation is necessary, the transmission frequency adjusting unit 10 performs frequency compensation for the signal modulated/coded by the modulation unit 9 by using the frequency offset stored in the second storage unit 702.

The D/A converter 11 converts the digital signal output from the transmission frequency adjusting unit 10 into an analog signal.

The high-frequency circuit unit 12 includes a filter, an amplifier, a frequency converter, and a quadrature modulator. The high-frequency circuit unit 12 generates a signal to be transmitted by the antenna 1 by upconverting the carrier frequency of the signal in the baseband (output from the D/A converter 11) using an output signal from the local oscillator 13.

The signal generated by the high-frequency circuit unit 12 is transmitted as a radio signal via the antenna 1.

With this arrangement, the wireless communication apparatus according to this embodiment can hold a frequency offset in accordance with a received packet, and transmit the transmission signal upon performing proper frequency correction for the signal which requires compensation. This makes it possible to suppress, within a predetermined range, frequency offsets in radio signals multiplex-transmitted by using SDMA, MultiUser-MIMO, OFDMA, or the like. As a consequence, the receiving station can correctly receive the multiplex-transmitted radio signals.

The wireless communication apparatus according to this embodiment can also be applied to a system designed to match the frequency of a wireless base station. That is, the wireless communication apparatus according to this embodiment is used as a wireless station belonging to the wireless base station. Assume that the wireless station is to transmit a radio signal to a wireless base station different from the wireless base station to which the wireless station belongs. In this case, the wireless station can properly compensate transmission frequencies both when it transmits a radio signal to the wireless base station to which the wireless station belongs and when it transmits a radio signal to another wireless base station to which the wireless station dose not belong.

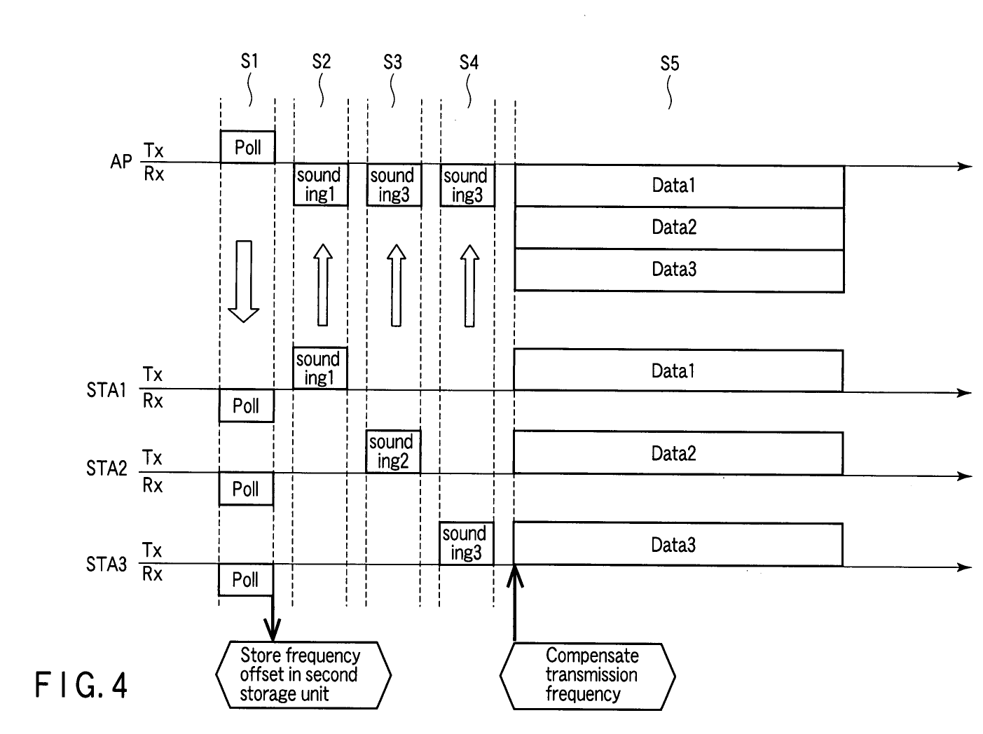

FIG. 4 shows an example of a communication sequence for transmission/reception between wireless stations STA1 to STA3, each having an arrangement like that shown in FIG. 1 or 2, and a wireless base station AP.

In step S1, the wireless stations STA1 to STA3 receive the poll frame transmitted by the wireless base station AP.

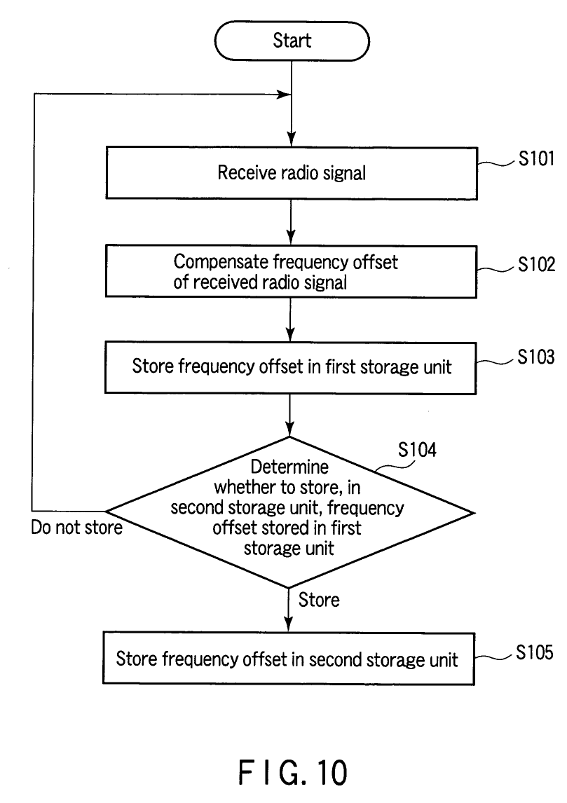

The processing operation to be performed when the wireless stations STA1 to STA3 receive the signal transmitted by the wireless base station AP will be described with reference to FIG. 10. FIG. 10 is a flowchart for explaining the processing operation of a main part according to this embodiment which is to be performed when wireless communication apparatuses (the wireless stations STA1 to STA3 in this case) each having an arrangement like that shown in FIG. 1 or 2 receive the signal transmitted from the wireless base station AP.

The signal of the poll frame received by the antenna 1 of each wireless station in step S101 is input to the reception frequency adjusting unit 4 via the high-frequency circuit unit 2 and the A/D converter 3. The reception frequency adjusting unit 4 detects a frequency offset in the signal output from the A/D converter 3, and determines a frequency offset for the reception signal on the basis of the detected frequency offset, thereby performing frequency compensation (step S102). The reception frequency adjusting unit 4 stores the frequency offset used for the frequency compensation of the reception signal in the first storage unit 701 (step S103). The demodulation unit 5 demodulates/decodes the reception signal after frequency compensation. The reception signal analyzing unit 6 then obtains the type, destination address, and transmission source address of the demodulated/decoded signal. The storage control unit 601 further determines, on the basis of the obtained transmission source address and the like, whether to store, in the second storage unit 702, the frequency offset stored in the first storage unit 701 in step S103 (used for the reception processing of the frame) (step S104).

Assume that the obtained transmission source address coincides with the address of the wireless base station AP (the destination address of the frame transmitted from the wireless station), or the reception frame is a frame which permits multiplex transmission from the wireless base station AP. In this case, the frequency offset used when the frame was received, which is stored in the first storage unit 701 in step S103, is selected, and the selected frequency offset is stored in the second storage unit 702 in step S105.

Referring back to FIG. 4, when the frequency offset used for reception processing for the poll frame is stored in the second storage unit 702 in this manner, each wireless station (STA1 to STA3) transmits a sounding frame to the wireless base station AP to allow the wireless base station AP to form a reception beam for the reception of the signal transmitted by each wireless station in steps S2 to S4. At this time, the destination address of the sounding frame coincides with the wireless base station AP, and the transmission source addresses coincide with the addresses of the wireless stations (STA1 to STA3). When, therefore, a given wireless station receives the sounding frame transmitted by another wireless station, the storage control unit 601 of the given wireless station does not store the frequency offset used for the reception processing in the second storage unit 702 (even if stored in the first storage unit 701). That is, the process returns from step S104 in FIG. 10 to a signal reception wait state.

In step S5, when transmitting a data frame to the wireless base station AP, each wireless station receives a compensate instruction for a transmission frequency from the compensation control unit 801, and causes the transmission frequency adjusting unit 10 to compensate the transmission frequency by using the frequency offset stored in the second storage unit 702. The data frame is transmitted with such frequency after the compensation.

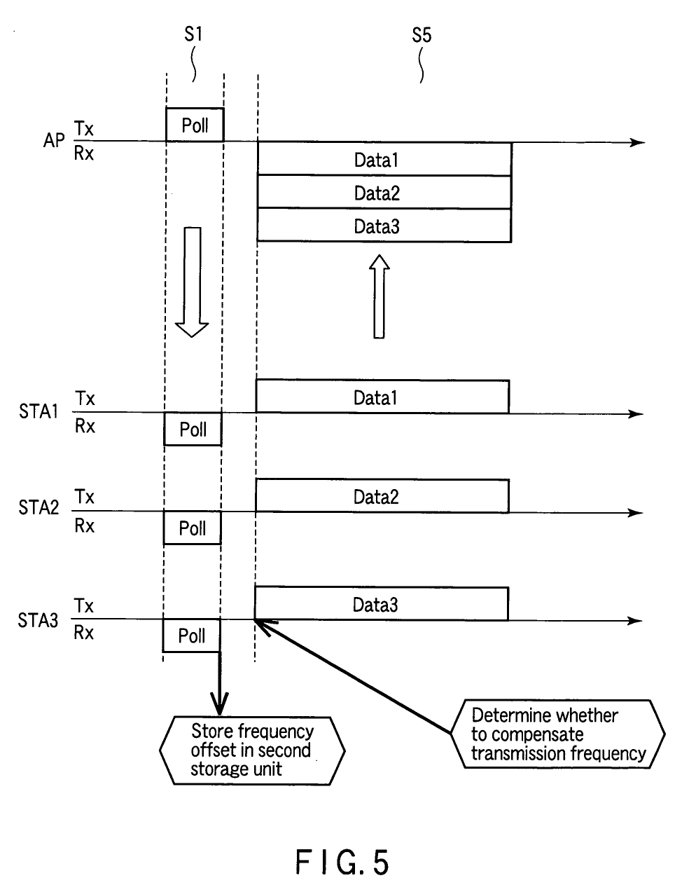

When the wireless stations STA1 to STA3 are to transmit no sounding frame, it suffices to skip steps S2 to S4, as shown in FIG. 5.

Determination on whether the frequency offset temporarily stored in the first storage unit 701 is to be stored in the second storage unit 702, i.e., the processing operation of the storage control unit 601, will be described next. The frequency offset to be stored in the second storage unit 702 is used to perform frequency compensation of a transmission signal. The number of frequency offsets stored in the first storage unit 701 and the second storage unit 702 may be singular or plural. If the number of frequency offsets is plural, frequency offsets are stored in sets with the identifiers (e.g., MAC addresses) of wireless stations (the transmission sources of reception signals). For this reason, when a given wireless station receives a radio signal having, as a transmission source address, the destination address of the radio signal transmitted by itself, the frequency offset used for reception processing for the signal is temporarily stored in the first storage unit 701. The storage control unit 601 then transfers the frequency offset to the second storage unit 702 and stores the value therein.

When, for example, the wireless stations STA1 to STA3 transmit radio signals multiplexed by SDMA, MU-MIMO, or OFDMA to the wireless base station, the destination address of data multiplex-transmitted by each wireless station is the address of the wireless base station. If, therefore, the transmission source address of the signal received by each wireless station coincides with the address of the wireless base station, the storage control unit 601 determines to store the frequency offset used for reception processing for the radio signal in the second storage unit 702.

Likewise, when the wireless stations STA1 and STA2 are to transmit radio signals multiplexed by SDMA, MU-MIMO, or OFDMA to the wireless station STA3, the destination address of the data transmitted by each of the wireless stations STA1 and STA2 is the address of the wireless station STA3. If, therefore, the transmission source address of the signal received by each of the wireless stations STA1 and STA2 coincides with the address of the wireless station STA3, the storage control unit 601 determines to store, in the second storage unit 702, the frequency offset used for reception processing for the radio signal.

In a system designed to perform communication between wireless base stations, when one wireless base station has received a radio signal having a transmission source address coinciding with the address of the other wireless base station, the storage control unit 601 of one wireless base station determines to store, in the second storage unit 702, the frequency offset used for reception processing for the received radio signal.

In this manner, the storage control unit 601 compares the address of a received signal with the address of the signal to be transmitted by the station itself to determine whether to store the frequency offset (stored in the first storage unit 701) in the second storage unit 702.

Assume that after a frequency offset is stored in the second storage unit 702, the wireless station receives a radio signal transmitted by another wireless station before actually transmitting a frequency-compensated signal, and compensates a frequency offset for reception processing for the radio signal. Even in this case, the offset is stored in only the first storage unit 701. The desired frequency offset used for transmission can therefore be kept held in the second storage unit 702.

A conventional wireless station includes neither the second storage unit 702 described above nor the storage control unit 601 which determines whether to store a frequency offset in the second storage unit 702. For this reason, every time a radio signal is received, a frequency offset is overwritten, resulting in the inability to perform proper frequency compensation processing required for a desired transmission signal. In contrast, the above embodiment can solve this problem and perform proper frequency compensation for a transmission signal requiring frequency compensation.

A method of determining whether to compensate the frequency of a transmission signal by using the frequency offset stored in the second storage unit 702, i.e., the processing operation of the compensation control unit 801, will be described next.

The compensation control unit 801 included in the transmission signal processing unit 8 checks the destination address of a transmission signal. If this address coincides with the address of a frequency compensation target, the compensation control unit 801 determines to perform compensation by using the frequency offset stored in the second storage unit 702. If there is one address as a compensation target, it suffices if the second storage unit 702 stores only a frequency offset. If there are a plurality of addresses as compensation targets, the second storage unit 702 stores each transmission destination address and a corresponding frequency offset as one combination. The compensation control unit 801 selects a frequency offset corresponding to the destination address of a transmission signal from the frequency offsets stored in the second storage unit 702, and outputs the selected frequency offset to the transmission frequency adjusting unit 10. The transmission frequency adjusting unit 10 receives this output frequency offset and compensates the transmission frequency.

A concrete example of a method of determining an address as a frequency compensation target will be described below.

In a system in which a wireless base station or a master station having a function similar to that of a wireless base station permits each wireless station (wireless terminal) to perform multiplex transmission such as SDMA, MU-MIMO, or OFDMA transmission, a destination address for multiplex transmission is written in a frame which permits multiplex transmission by the wireless base station or the master station. When the reception signal analyzing unit 6 of the wireless station receives/acquires a frame which permits this multiplex transmission, the storage control unit 601 determines the destination address of the frame as the address of a frequency compensation target.

If the destination address of multiplex transmission is determined in advance as the address of a wireless station which has transmitted the frame which permits multiplex transmission, the transmission source address of the frame which permits multiplex transmission becomes the address of the frequency compensation target. In this case, when the reception signal analyzing unit 6 of the wireless station receives/acquires this frame which permits multiplex transmission, the storage control unit 601 determines the transmission source address of the frame as the address of the frequency compensation target.

If a wireless station keeps establishing frequency synchronization with a wireless base station to which the wireless station belongs, the storage control unit 601 determines the address of the wireless base station to which the wireless station belongs as the address of the frequency compensation target. The second storage unit 702 then stores the frequency compensation value used for reception processing for the radio signal transmitted from the wireless base station to which the wireless station belongs. Upon receiving the radio signal transmitted from a station other than the wireless base station, the frequency compensation value used for the reception processing is held in the first storage unit 701 but is not stored in the second storage unit 702. For a radio signal to be transmitted to the wireless base station to which the wireless station belongs, the wireless station transmits the signal upon performing frequency compensation using the frequency offset stored in the second storage unit 702. Assume that a wireless station is to transmit a radio signal to a station other than the wireless base station to which the wireless station belongs. In this case, it sometimes suffices to perform frequency compensation by using the same value as that of a signal transmitted to the wireless base station to which the wireless station belong or not to perform frequency compensation. This depends on the system. Therefore, an example of an arrangement which can deal with either of the cases is disclosed, and the algorithm to be used is not specifically limited.

### Second Embodiment

The present invention can be applied to a method of establishing frequency synchronization with a wireless station to which a TXOP (Transmission Opportunity) access right is given upon acquisition of TXOP in TXOP transmission standardized in IEEE802.11e wireless LAN regardless of whether multiplex transmission is performed.

The arrangement of a wireless station according to this embodiment is the same as that shown in FIG. 1 or 2.

When a wireless station is to perform burst-like communication with a wireless base station by using TXOP transmission, the wireless station transmits a transmission request frame (e.g., an RTS frame) to the wireless base station. A TXOP period is written in this RTS frame. Upon receiving a transmission response frame (e.g., a CTS frame) from the wireless base station, the wireless station stores the frequency offset used for reception processing for a CTS frame in a second storage unit 702. Upon receiving a CTS frame, the wireless station determines that a transmission right is given for the TXOP period written in the CTS frame. All frames addressed to a wireless base station which are transmitted during the TXOP period are transmitted after transmission frequencies are compensated by using the frequency offset stored in the second storage unit 702.

Note that if the wireless station receives a frame transmitted by a wireless base station to which a TXOP transmission right is given during the TXOP period, the wireless station can update the frequency offset which has already been stored in the second storage unit 702 by using the frequency offset used for the reception of the frame.

In this case, the destination address of an RTS frame is set to a wireless base station. However, it suffices to set the address to another wireless station other than the wireless station as well as the wireless base station. For example, TXOP transmission can be performed in direct link transmission in IEEE802.11.

A case in which the second storage unit 702 can store only one frequency offset will be described below. Assume that the first wireless station according to this embodiment receives a frame transmitted by a wireless station other than the second wireless station (which has transmitted a CTS frame) which has given a transmission right to the first wireless station during the TXOP period given to the first wireless station by the second wireless station, and that the transmission source address is the address of the wireless station to which the first wireless station wants to transmit a signal afterward.

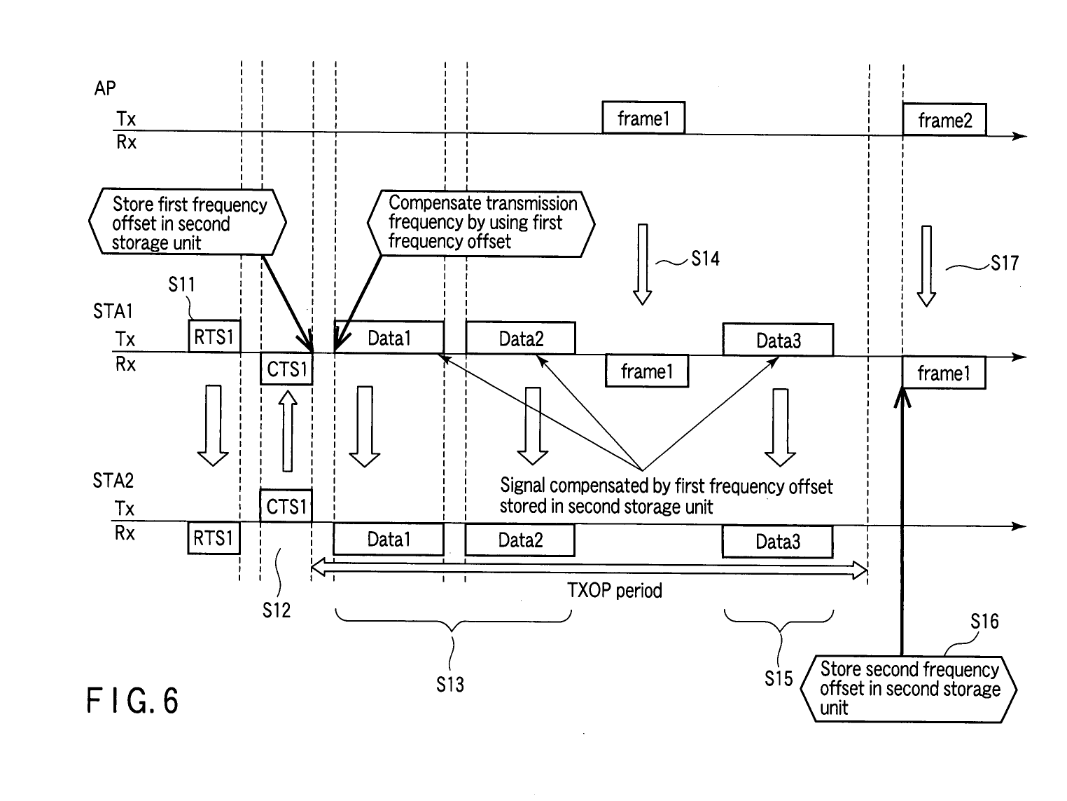

More specifically, as shown in FIG. 6, a first wireless station STA1 transmits an RTS frame to a second wireless station STA2 (step S11), and receives a CTS frame transmitted from the second wireless station. At this time, a storage control unit 601 of the first wireless station STA1 determines to store, in the second storage unit 702, the first frequency offset which has been used for reception processing for the CTS frame and is temporarily stored in a first storage unit 701 (step S12). Thereafter, the first wireless station STA1 performs frequency compensation by using the first frequency offset stored in the second storage unit 702 during the TXOP period given from the second wireless station STA2, and transmits the resultant signal to the second wireless station STA2 (step S13). Assume that the first wireless station STA1 has received a frame transmitted from the wireless base station AP to which the wireless station belongs during this TXOP transmission (step S14).

Even if the first wireless station STA1 receives a frame having a transmission source address coinciding with the wireless base station AP to which the first wireless station STA1 belongs during the TXOP period given by the second wireless station STA2, the first wireless station STA1 does not store the second frequency offset used for reception processing for the frame (stored in the first storage unit 701) in the second storage unit 702 in step S14. Subsequently, therefore, when transmitting a radio signal to the second wireless station STA2 during the TXOP period, the first wireless station STA1 transmits the radio signal which is frequency-compensated by using the first frequency offset which has already been stored in the second storage unit 702 (step S15). With this operation, even if the wireless station receives a frame transmitted by a wireless station other than the wireless station which has permitted TXOP, and the second storage unit 702 can store only one frequency offset, it is possible to compensate a radio signal transmitted during the TXOP period by using a proper frequency offset corresponding to the transmission destination wireless station.

When the TXOP period is over, the storage control unit 601 of the first wireless station STA1 determines to store, in the second storage unit 702, the second frequency offset which has been used for the reception of a frame transmitted from the wireless base station AP in step S14 and stored in the first storage unit 701. Alternatively, the storage control unit 601 determines to store, in the second storage unit 702, the second frequency offset which has been used (stored in the first storage unit 701) for the reception of a frame retransmitted from the wireless base station AP after the end of the TXOP period. As a consequence, the second frequency offset is stored in the second storage unit 702 (step S16). Thereafter, the first wireless station STA1 compensates a transmission frequency by using the second frequency offset stored in the second storage unit 702, and transmits the resultant frame to the wireless base station AP (step S17).

### Third Embodiment

In a transmission scheme other than multiplex transmission, a wireless station may set, as a frequency compensation target, the address of a wireless base station other than the wireless base station to which the wireless station belongs. In a mesh-type system, a wireless base station may set the address of another wireless base station other than the wireless base station as a frequency compensation target.

In this case, the arrangement of a wireless station and wireless base station is the same as that shown in FIG. 1 or 2.

In the former case, the wireless station (a storage control unit 601) stores, in a second storage unit 702 in advance, not only the frequency offset used for the reception of a radio signal transmitted from the wireless base station to which the wireless station belongs but also the frequency offset used for the reception of a radio signal transmitted by another wireless base station, in correspondence with the address of each wireless base station. When a radio signal is to be transmitted to another wireless base station, a compensation control unit 801 selects a frequency offset corresponding to the address of another wireless base station from the frequency offsets stored in the second storage unit 702, performs frequency compensation by using the frequency offset, and transmits the resultant signal.

In the latter case, each wireless terminal (wireless station) belonging to a wireless base station sometimes holds a frequency offset matching the frequency of the wireless base station. Therefore, after the wireless base station transmits a frequency-compensated radio signal to another wireless base station, the frequency offset is restored to the value before the frequency compensation. That is, the wireless base station performs communication upon properly selecting a frequency offset to be applied depending on whether the base station transmits a signal to a wireless station belonging to the wireless base station or to another wireless base station.

The wireless base station determines, by using a network identifier or the like given to the wireless base station in advance, whether the transmission source of a received frame is another wireless base station. If the wireless base station uses a protocol which inserts, in a frame, information identifying the frame transmitted from the wireless base station to a wireless station, no explicit network identifier is required. In this case, the transmission source address of this frame can be interpreted as a network identifier for identifying another wireless base station. This makes it possible to transmit a frequency-synchronized radio signal to another wireless base station.

Assume that after the wireless base station transmitted a frame by using a frequency offset corresponding to another wireless base station, the wireless base station has not performed frequency compensation by calibration or the like in transmission. In this case, the transmission frequency can be restored to the original transmission frequency by setting the frequency offset to “0”. If the wireless base station has performed frequency compensation, it suffices to store the original frequency offset used by the wireless base station in the second storage unit 702. Subsequently, if the wireless base station performs frequency compensation by using this original frequency offset when transmitting a signal to a wireless station belonging to the wireless base station, the transmission frequency can be restored to the original transmission frequency.

In a system including a plurality of wireless base stations and wireless terminals belonging to the respective wireless base stations, it is possible to implement both communication between wireless base stations and communication with wireless terminals in this manner without establishing frequency synchronization among all wireless base stations.

### Fourth Embodiment

When a wireless base station having the arrangement shown in FIG. 1 or 2 receives a signal transmitted from each wireless station located in the communication area of the wireless base station, the frequency offset of the signal used for reception processing for the signal is stored in a second storage unit 702 together with the address of each wireless station. When transmitting a radio signal to each wireless station, the wireless station transmits the signal upon performing frequency compensation by using the frequency offset which corresponds to the wireless station and is stored in the second storage unit 702. As a consequence, even if a communication environment is poor or the frequency compensation ability of a wireless station is low, since the wireless base station can perform proper frequency compensation on the wireless base station side, the communication quality can be improved.

### Fifth Embodiment

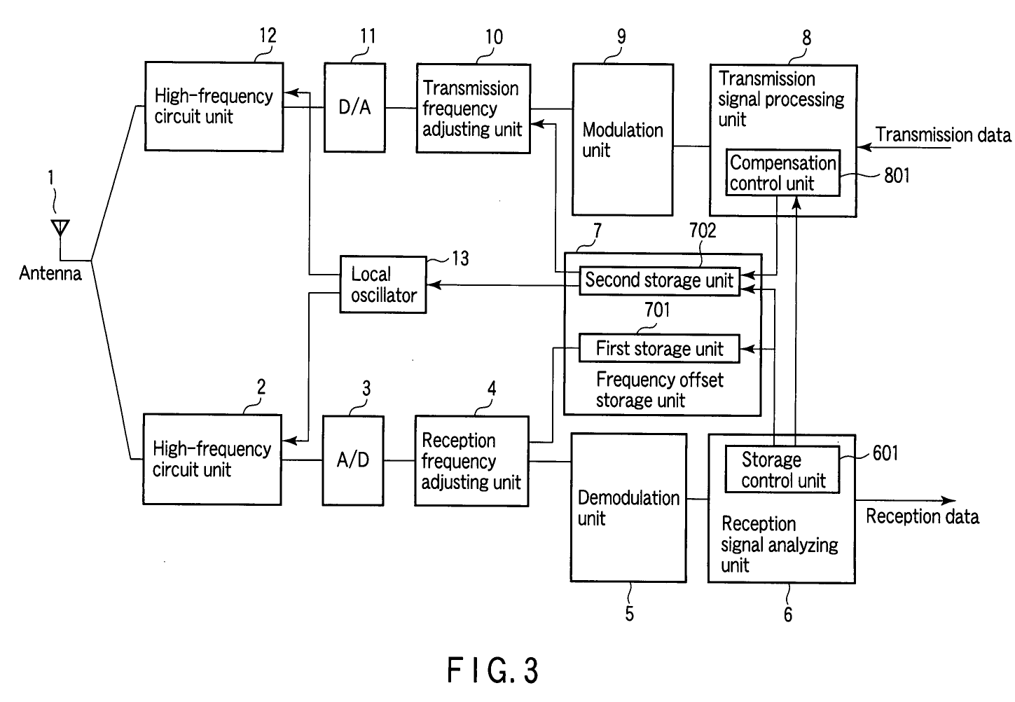

In the first to fourth embodiments described above, the transmission frequency adjusting unit 10 digitally performs frequency compensation processing for a transmission signal. However, the present invention is not limited to this case. If a frequency offset is equal to or more than a predetermined threshold, the arrangement shown in FIG. 3 can be used. The same reference numerals as in FIG. 1 denote the same parts in FIG. 3, and different portions will be described. That is, in the arrangement of the wireless communication apparatus in FIG. 3, a compensation control unit 801 controls the oscillator-frequency of a local oscillator 13 by using the frequency offset stored in a second storage unit 702, controls the frequency compensation amount of a transmission frequency adjusting unit 10, and performs frequency compensation for a transmission signal by using both the local oscillator 13 and the transmission frequency adjusting unit 10.

When the second storage unit 702 is to store a plurality of frequency offsets, the oscillator-frequency of the local oscillator 13 is compensated in advance to implement frequency compensation by using any of the frequency offsets merely by causing the transmission frequency adjusting unit 10 to perform adjustment. This operation can easily cope with even a case in which it is difficult to control the oscillator-frequency of the local oscillator 13 in real time.

When the oscillator-frequency of the local oscillator 13 is controlled to compensate the frequency of a transmission signal to the first wireless station, the frequency compensation amount of the transmission signal to the second wireless station changes. If it is necessary to control the oscillator-frequency of the local oscillator 13 to compensate the frequency of a transmission signal to the second wireless station, the oscillator-frequency of the local oscillator 13 is compensated to a value suitable for both the first wireless station and the second wireless station in advance, and the residual compensation amount is adjusted by the transmission frequency adjusting unit 10.

Assume that a threshold for the frequency compensation amount of the transmission frequency adjusting unit 10 is 150 kHz, and it is necessary to perform frequency compensation corresponding to +200 kHz and +100 kHz for the first and second wireless stations. In such a case, the oscillator-frequency of the local oscillator 13 is compensated by +200 kHz, and the transmission frequency adjusting unit 10 performs frequency compensation for the first and second wireless stations by 0 kHz and −100 kHz, respectively. Alternatively, the oscillator-frequency of the local oscillator 13 is compensated by +150 kHz, and the transmission frequency adjusting unit 10 performs frequency compensation for the first and second wireless stations by +50 kHz and −50 kHz, respectively.

Compensating the oscillator-frequency of the local oscillator 13 in this manner can reduce the frequency compensation amount in the reception frequency adjusting unit 4 when signals transmitted by the first and second wireless stations are received.

More specifically, if the oscillator-frequency of the local oscillator 13 is not compensated, frequency compensation corresponding to 200 kHz is required for the reception frequency adjusting unit 4. In contrast, compensating the oscillator-frequency of the local oscillator 13 by +200 kHz or +150 kHz can set the frequency compensation amount in the reception frequency adjusting unit 4 to 100 kHz or ±50 kHz.

As a consequence, processing by the reception frequency adjusting unit 4 can be more simplified. Alternatively, the range in which frequency offset compensation can be performed can be extended.

If the oscillator-frequency of the local oscillator 13 can be compensated in real time, when a signal is to be transmitted to the second wireless station, the transmission frequency adjusting unit 10 performs compensation corresponding to 100 kHz without compensating the oscillator-frequency of the local oscillator 13. In contrast, when a signal is to be transmitted to the first wireless station, since the required compensation amount of 200 kHz exceeds the threshold of 150 kHz of the transmission frequency adjusting unit 10, the oscillator-frequency of the local oscillator 13 is compensated by 150 kHz, and the transmission frequency adjusting unit 10 performs compensation corresponding to 50 kHz, i.e., the remaining component to be compensated. This can reduce the compensation amount required for the transmission frequency adjusting unit 10, and hence can simplify processing by the transmission frequency adjusting unit 10. Note that if a common local oscillator is used for transmission and reception, the value compensated in the local oscillator at the time of transmission is restored to the original value.

The first to fifth embodiments can also be applied to the wireless station and the wireless base station each having the arrangement shown in FIG. 3.

### Sixth Embodiment

The following is a case in which each transmitting-side wireless communication apparatus adjusts a frequency compensation amount for a receiving-side wireless communication apparatus, which is stored in a second storage unit 702, on the basis of the feedback offset transmitted from the receiving-side wireless communication apparatus. In this case, at least the transmitting-side wireless communication apparatus will have one of the arrangements shown in FIGS. 1 to 3. In addition, this embodiment can also be applied to a case in which the receiving-side wireless communication apparatus has one of the arrangements shown in FIGS. 1 to 3.

When a plurality of wireless stations multiplex-access the wireless base station by SDMA, MU-MIMO, OFDMA, or the like, each wireless station (transmitting-side wireless communication apparatus) transmits, to the wireless base station (receiving-side wireless communication apparatus), a radio signal which is frequency-compensated by the above method. If further frequency compensation is required for multiplex access, the wireless base station further feeds back a frequency offset to each wireless station. An identifier or the like which indicates that this frequency offset is fed back is added to a radio signal to be transmitted from the wireless base station to feed back the frequency offset. Alternatively, each wireless station determines, by analyzing a received frame, that a frequency offset is fed back.

Upon receiving the frame containing the frequency offset (feedback offset) fed back from the wireless base station, the wireless station corrects or adjusts the frequency offset for the wireless base station, which is stored in the second storage unit 702, by using the feedback offset without storing the frequency offset of the frame used for the reception of the frame in the second storage unit 702.

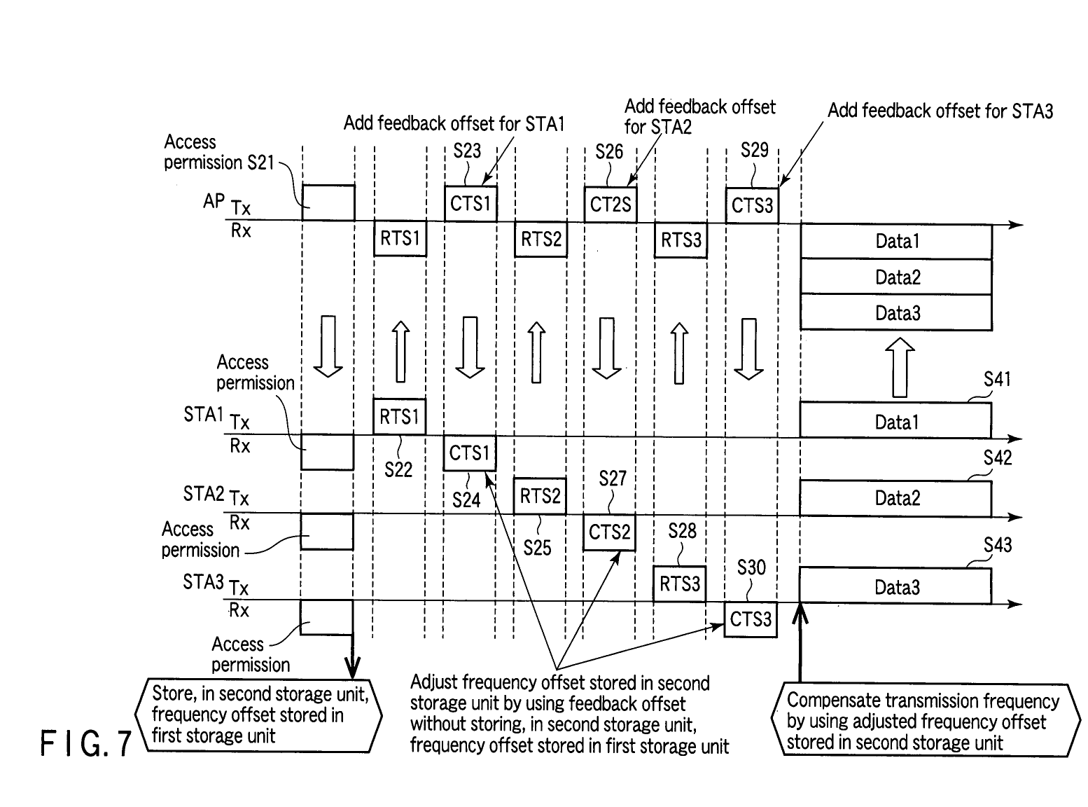

This operation will be concretely described below with reference to FIG. 7. FIG. 7 shows a communication sequence between a wireless base station and a plurality of (three in this case) wireless stations in a case in which each of wireless stations STA1 to STA3 adjusts a frequency offset corresponding to a wireless base station AP by using the feedback offset transmitted from the wireless base station AP.

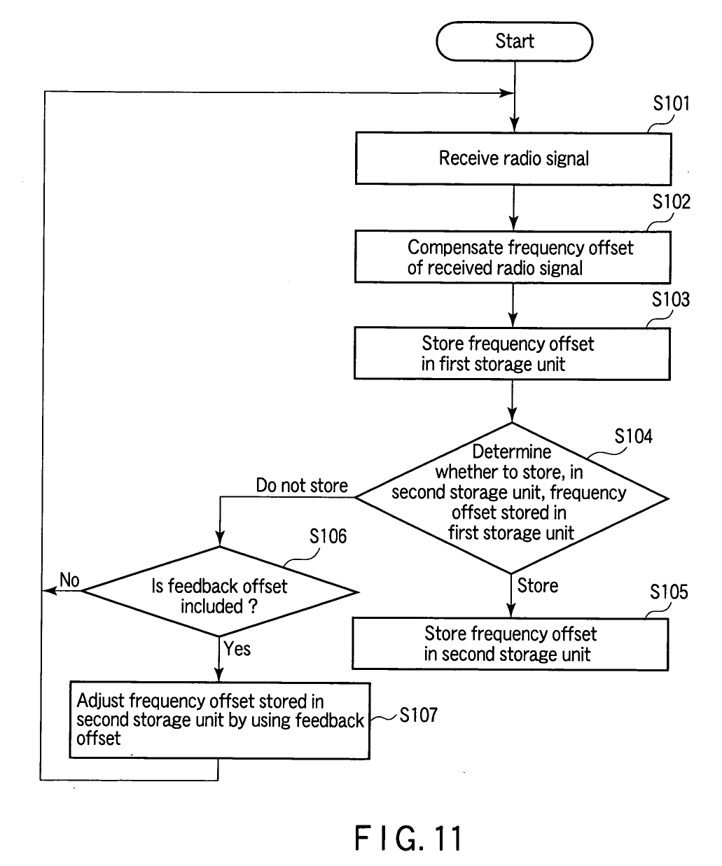

FIG. 11 shows the processing operation to be performed when each of the wireless stations STA1 to STA3 receives the signal transmitted from the wireless base station AP. Note that the same reference numerals as in FIG. 10 denote the same parts in FIG. 11.

When each of the wireless stations STA1 to STA3 receives the access permission signal transmitted by the wireless base station AP in step S21 in FIG. 7, the wireless station stores the frequency offset used for the reception processing (stored in the first storage unit 701) in the second storage unit 702 (steps S101 to S105 in FIG. 11).

Each of the wireless stations STA1 to STA3 then compensates the transmission frequency by using the frequency offset stored in the second storage unit 702 and transmits an RTS frame to the wireless base station AP.

For example, in step S22, the wireless station STA1 compensates the transmission frequency by using the frequency offset stored in the second storage unit 702 and transmits an RTS frame (RTS1) to the wireless base station AP. Upon receiving the RTS frame, the wireless base station AP determines, on the basis of the frequency offset used for the reception processing, whether it is necessary to further adjust the frequency offset used at the time of transmission of the RTS frame from the wireless station STA1. If the wireless base station AP determines that it is necessary to adjust the frequency offset used when the wireless station STA1 has transmitted the RTS frame, the wireless base station AP determines a feedback offset for adjusting the frequency offset. For example, the wireless base station AP determines the frequency offset used for reception processing for the RTS frame from the wireless station STA1 as a feedback offset.

In step S23, the wireless base station AP adds the determined feedback offset and information (an identifier or the like) associated with the feedback offset to a CTS frame, and transmits the CTS frame (CTS1) containing the feedback offset to the wireless station STA1.

In step S24, the wireless station STA1 receives the CTS frame (CTS1) (steps S101 to S103 in FIG. 11). If a storage control unit 601 of the reception signal analyzing unit 6 determines from the information or the like added to this CTS frame that the CTS frame contains a feedback offset (steps S104 and S106 in FIG. 11), the storage control unit 601 does not select the frequency offset used for reception processing for the CTS frame (which is currently stored in a first storage unit 701). That is, although the frequency offset is not stored in the second storage unit 702, the frequency offset stored in the second storage unit 702 is adjusted by using the feedback offset contained in the CTS frame (step S107 in FIG. 11).

In step S41, when transmitting data to the wireless base station, the wireless station STA1 (a transmission frequency adjusting unit 10 or the transmission frequency adjusting unit 10 and a local oscillator 13) compensates the transmission frequency by using the frequency offset adjusted by the feedback offset stored in the second storage unit 702.

Both the operation to be performed when the wireless station STA2 transmits an RTS frame (RTS2) to the wireless base station AP (steps S25 to S27 and S42) and the operation to be performed when the wireless station STA3 transmits an RTS frame (RTS3) to the wireless base station AP (steps S28 to S30 and S43) are the same as the above operation to be performed when the wireless station STA1 transmits an RTS frame to the wireless base station AP (steps S22 to S24 and S41).

As described above, in the above embodiment, a wireless base station (receiving-side wireless communication apparatus) which has received a signal from a wireless station (transmitting-side wireless communication apparatus) transmits a feedback offset based on the frequency offset used at the time of the reception of the signal to the wireless station as the transmission source of the signal. The wireless station can adjust the frequency offset corresponding to the wireless base station by using the received feedback offset. Therefore, a frequency offset corresponding to the wireless base station, i.e., a frequency offset, in each wireless station can be further suppressed.

### Seventh Embodiment

In the sixth embodiment, when the transmitting-side wireless communication apparatus receives a CTS frame (steps S24, S27, and S30 in FIG. 7), in order to determine whether to select the frequency offset (stored in the first storage unit 701) used for reception processing for the frame (i.e., whether to store the frequency offset used for reception processing for the CTS frame in the second storage unit 702), the storage control unit 601 checks whether a feedback offset is contained in the received CTS frame. If the received CTS frame contains a feedback offset, this apparatus adjusts the frequency offset stored in the second storage unit 702 by using the feedback offset without storing the frequency offset in the second storage unit 702.

In order to allow a transmitting-side wireless communication apparatus to more easily determine in step S24, S27, or S30 in FIG. 7 not to select the frequency offset used for reception processing for the frame (i.e., not to store the frequency offset in a second storage unit 702), an unused field in a frame is provided with a permission/inhibition bit to permit/inhibit storage of the frequency offset used at the time of the reception of the frame (stored in a first storage unit 701) in the second storage unit 702.

If, for example, the permission/inhibition bit in a frame is set to “1”, it indicates “permission to hold frequency offset”. That is, this bit permits to store the frequency offset used at the time of the reception of the frame in the second storage unit 702. If the permission bit is set to “0”, it indicates “inhibition to hold frequency offset”. That is, this inhibits the frequency offset used at the time of the reception of the frame from being stored in the second storage unit 702.

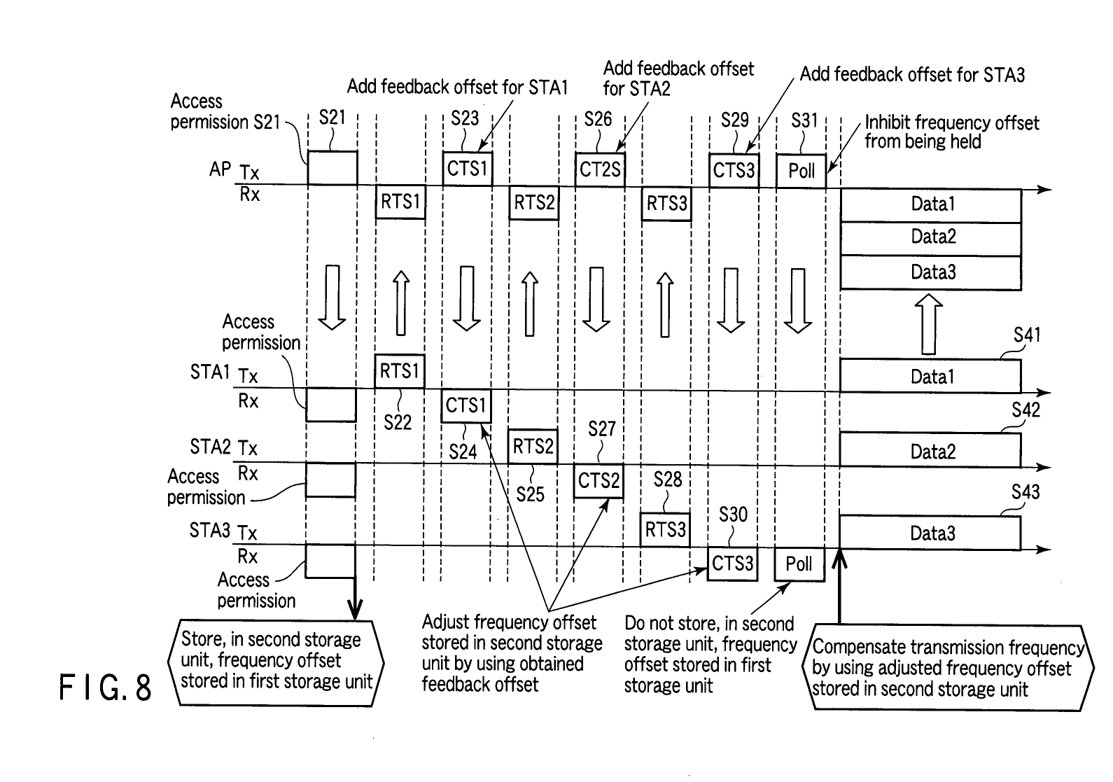

Consider a wireless communication system which uses a sequence in which the wireless base station AP notifies a selection result on a wireless station to which multiplex transmission is performed, by using a poll frame in step S31, on the basis of the result of RTS/CTS exchange (steps S22 to S30) after an access permission signal is transmitted in step S21, as shown in FIG. 8.

The same reference numerals as in FIG. 7 denote the same parts in FIG. 8.

As described in the sixth embodiment, in steps S24, S27, and S30, since a CTS frame contains a feedback offset and the permission/inhibition bit is “0”, each of wireless stations STA1 to STA3 determines not to store the frequency offset used for reception processing for the frame in the second storage unit 702, and adjusts the frequency offset stored in the second storage unit 702 by the feedback offset.

In step S31, the wireless base station AP transmits a poll frame with the permission/inhibition bit being set to “0” to inhibit the frequency offset used at the time of the reception of the poll frame from being stored in the second storage unit 702. That is, the wireless base station AP notifies the wireless station of inhibition to hold the frequency offset by using the poll frame.

Notifying the wireless station of inhibition to hold a frequency offset by using a poll frame in this manner can prevent a desired frequency offset, which is notified from the wireless base station AP by using a CTS frame, from being overwritten by the frequency offset used for reception processing for the poll frame.

Using this method makes it unnecessary for the wireless base station AP to designate the transmission timing of each of wireless stations STA1 to STA3 in the interval between the instant an access permission signal is transmitted and the instant a poll frame is transmitted. In addition, the wireless base station can select wireless stations which can be multiplexed upon grasping transmission path information in RTS/CTS exchange.

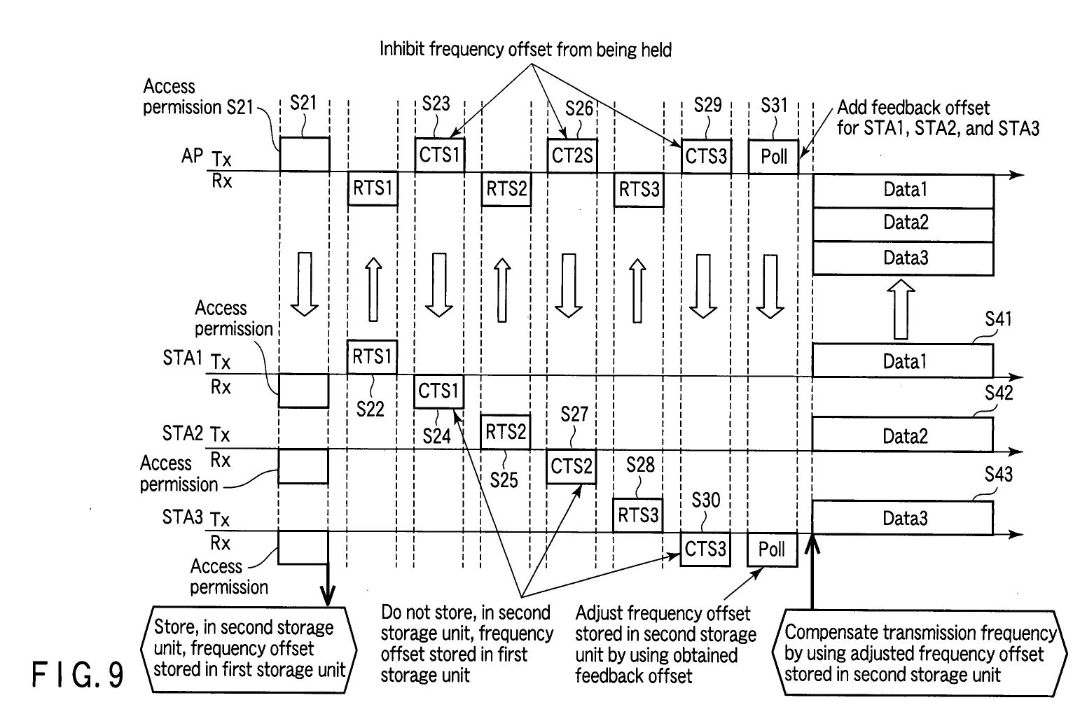

FIG. 9 shows a communication sequence between the wireless base station AP and the wireless stations STA1 to STA3 in a case in which the wireless base station AP notifies a selected one of the wireless stations STA1 to STA3 of a feedback offset by using a poll frame instead of a CTS frame. Note that the same reference numerals as in FIG. 8 denote the same parts in FIG. 9.

Referring to FIG. 9, when each of the wireless stations STA1 to STA3 receives a CTS frame (step S24, S27, or S30 in FIG. 9), since the permission/inhibition bit in the CTS frame is “0”, the storage control unit 601 of each of the wireless stations STA1 to STA3 determines not to store the frequency offset used for reception processing for the frame in the second storage unit 702. Note that since no feedback offset is contained in a CTS frame, the frequency offset stored in the second storage unit 702 (used at the time of the reception of the access permission frame transmitted in step S21) is not adjusted by the feedback offset.

In step S31, since the poll frame containing the feedback offset and the permission/inhibition bit “0” is transmitted to the wireless station STA3, the wireless station STA3 determines not to store the frequency offset used for reception processing for the frame in the second storage unit 702, and adjusts the frequency offset stored in the second storage unit 702 by using the feedback offset. Thereafter, in step S43, when data is to be transmitted to the wireless base station AP, the transmission frequency adjusting unit 10 compensates the transmission frequency by using the compensated frequency offset stored in the second storage unit 702.

Using this method makes it possible for the wireless base station AP to, for example, select only wireless stations to be multiplexed that have small frequency offsets with respect to the wireless base station AP.

As described above, according to the first to seventh embodiments, each wireless communication apparatus stores a frequency offset corresponding to another arbitrary wireless communication apparatus in the second storage unit 702 and compensates the frequency of a transmission signal to the other wireless communication apparatus by using the frequency offset stored in the second storage unit 702 in order to transmit a signal to the other wireless communication apparatus. This makes it possible to easily and properly compensate the frequency offset between the wireless communication apparatuses, thereby implementing high-quality communication without any frequency offset.

According to the above embodiments, it is possible to provide a wireless communication apparatus and wireless communication method which can easily and properly compensate frequency offsets between wireless communication apparatuses.

AS a result, it is possible to perform spatial multiplexing (e.g., MU-MIMO or SDMA) communication or orthogonal frequency division multiple access (OFDMA) communication between a plurality of wireless communication apparatuses.

What is claimed is:

1. A wireless communication apparatus comprising:
a reception unit configured to receive a radio signal;
a reception frequency compensation unit configured to compensate, every time the radio signal is received by the reception unit, a frequency offset of the radio signal;
a control unit configured to store, in a memory, the frequency offset of the radio signal which includes an address used as a destination of a transmission signal;
a transmission frequency compensation unit configured to compensate a frequency of the transmission signal having the address as the destination by using the frequency offset stored in the memory; and
a transmission unit configured to transmit the transmission signal whose frequency is compensated by the transmission frequency compensation unit.

2. The apparatus according to claim 1, wherein the control unit stores, in the memory, the frequency offset of the radio signal including the address as the destination of the transmission signal to be subjected to one of spatial multiplexing and orthogonal frequency division multiple access.

3. The apparatus according to claim 1, wherein the control unit stores, in the memory, the frequency offset of the radio signal including, as a source address, the address which coincides with the destination of the transmission signal.

4. The apparatus according to claim 1, wherein the control unit stores, in the memory, the frequency offset of the radio signal which further includes information indicating a period during which transmission of the transmission signal is permitted, and
the transmission frequency compensation unit compensates the frequency of the transmission signal transmitted during the period by using the frequency offset stored in the memory.

5. The apparatus according to claim 1, wherein the control unit stores, in the memory, the frequency offset of the radio signal further including an identifier indicating a base station.

6. The apparatus according to claim 1, further comprising:
an oscillator to supply a frequency signal to the reception unit and the transmission unit, and wherein
the transmission frequency compensation unit compensates an oscillator-frequency of the oscillator and compensates the frequency of the transmission signal by using a remaining offset obtained by subtracting a compensation amount of the oscillator-frequency from the frequency offset stored in the memory.

7. The apparatus according to claim 1, wherein when the radio signal which is received by the reception unit after the transmission signal is transmitted by the transmission unit, includes, as a source address, the address which coincides with the destination, and includes a feedback offset, the control unit adjusts the frequency offset stored in the memory by using the feedback offset.

8. The apparatus according to claim 1, wherein
the reception unit receives the radio signal including one of first bit information which permits storing, in the memory, the frequency offset of the radio signal compensated by the reception frequency compensation unit and second bit information for inhibiting the frequency offset from being stored in the memory, and
the control unit (a) stores, in the memory, the frequency offset of the radio signal which includes, as a source address, the address coinciding with the destination and includes the first bit information, and
(b) does not store, in the memory, the frequency offset of the radio signal which includes, as the source address, the address coinciding with the destination and includes the second bit information.

9. The apparatus according to claim 8, wherein when the radio signal which is received by the reception unit after the transmission signal is transmitted by the transmission unit, includes, as a source address, the address which coincides with the destination, and includes the second bit information and a feedback offset, the control unit adjusts the frequency offset stored in the memory by using the feedback offset without storing, in the memory, the frequency offset of the radio signal.

10. The apparatus according to claim 1, wherein
the memory stores a plurality of frequency offsets corresponding to a plurality of destination addresses respectively, and
the transmission frequency compensation unit compensates the frequency of the transmission signal by using the frequency offset, of the frequency offsets stored in the memory, which corresponds to a destination address of the transmission signal.

11. A wireless communication method comprising:
receiving a radio signal;
compensating a frequency offset of received radio signal;
storing, in a memory, a frequency offset of the received radio signal which includes an address used as a destination of a transmission signal;
compensating a frequency of the transmission signal having the address as the destination by using the frequency offset stored in the memory; and
transmitting the transmission signal whose frequency is compensated.

12. The method according to claim 11, wherein storing stores, in the memory, the frequency offset of the received radio signal including the address as the destination of the transmission signal to be subjected to one of spatial multiplexing and orthogonal frequency division multiple access.

13. The method according to claim 11, wherein storing stores, in the memory, the frequency offset of the received radio signal including, as a source address, the address which coincides with the destination of the transmission signal.

14. The method according to claim 11, wherein storing stores, in the memory, the frequency offset of the received radio signal which further includes information indicating a period during which transmission of the transmission signal is permitted, and
compensating the frequency of the transmission signal compensates the frequency of the transmission signal transmitted during the period by using the frequency offset stored in the memory.

15. The method according to claim 1, wherein storing stores, in the memory, the frequency offset of the received radio signal which further includes an identifier indicating a base station.

16. The method according to claim 11, wherein
compensating the frequency of the transmission signal includes
compensating an oscillator-frequency of a oscillator to supply a frequency signal used to receive the radio signal and transmit the transmission signal; and
compensating the frequency of the transmission signal by using a remaining offset obtained by subtracting a compensation amount of the oscillator-frequency from the frequency offset stored in the memory.

17. The method according to claim 1, further comprising:
receiving, after the transmission signal is transmitted, a response signal responding to the transmission signal and including a feed back offset;
adjusting the frequency offset stored in the memory by using the feedback offset included in the response signal.

18. The method according to claim 11, wherein
receiving receives the radio signal including one of first bit information which permits storing, in the memory, the frequency offset of the radio signal compensated and second bit information for inhibiting the frequency offset from being stored in the memory, and
storing (a) stores, in the memory, the frequency offset of the radio signal which includes, as a source address, the address coinciding with the destination and includes the first bit information, and (b) does not store, in the memory, the frequency offset of the radio signal which includes, as the source address, the address coinciding with the destination and includes the second bit information.
